(19) United States
(12) Patent Application Publication
(10) Pub. No.: US 2008/0023212 A1
(43) Pub. Date: Jan. 31, 2008

(54) Cable pathway patch panel rack

(76) Inventors: Lars R. Larsen, Old Lyme, CT (US); Stewart A. Levesque, Scotland, CT (US)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(21) Appl. No.: 11/490,361

(22) Filed: Jul. 20, 2006

(51) Int. Cl. H02G 3/00

(52) U.S. Cl. 174/101

(57) ABSTRACT

Assemblies and methods for mounting a patch panel rack to a cable management pathway are provided. A typical assembly includes a patch panel rack adapted to host a plurality of ports. The patch panel rack is mounted onto two mounting brackets. The mounting brackets are mounted onto a cable management pathway. A cable management pathway is typically a wire raceway or a ladder rack. A waterfall adapted to guide telecommunication cables to desired destinations and also maintain a desired bend radius, is connected to a front face of the patch panel rack. The patch panel rack and the mounting brackets typically define a plurality of apertures adapted to adjustably mount each component respectively. In an exemplary embodiment, the patch panel rack and the mounting brackets define a substantially vertical slot adapted to adjustably mount each component respectively. U bolts are typically used to structurally secure the mounting bracket to the cable management pathway. A patch panel rack mounted on a cable management pathway allows for convenient and advantageous access to ports associated with a telecommunications cabinet.

### BACKGROUND

1. Technical Field

The present disclosure relates to assemblies and methods for mounting a patch panel rack to a cable pathway in a telecommunication data center.

2. Background Art

Modern buildings, particularly commercial buildings, require an effective and efficient telecommunications infrastructure to support the wide variety of services that rely on the electronic transport of information. Typically, wiring systems within buildings are terminated in a central wiring closet where they may be interconnected with one another, and/or to other cabling systems or telecommunications equipment. Cables are often terminated on wire panels (such as RJ-45 patch panels) or the like, which are mounted either to racks, or to stand-off brackets affixed to a wall.

Patch panels are well known in the field of data communication systems. A patch panel generally provides a plurality of network ports incorporated into a single structural element that connect incoming and outgoing lines of a local area network (LAN) or other communication, electronic or electrical system. Patch panels are usually housed within a telecommunications closet or in an alternative location appropriate for patching cables. Typical patch panels are mounted hardware units that include a plurality of port locations (e.g., twenty four or forty eight) that function as a sort of static switchboard, using cables to interconnect computers associated with a LAN and/or to connect computers to an outside network, e.g., for connection to the Internet or other wide area network (WAN). A patch panel generally uses a sort of jumper cable, called a patch cord, to create each interconnection.

In a typical installation, the patch panel connects a network's computers to each other and to the outside lines that enable the LAN to connect to the Internet or another WAN. Connections are generally made with patch cords and the patch panel allows circuits to be easily and efficiently arranged and rearranged by plugging and unplugging the patch cords. Patch panel systems are generally intended to facilitate organization and management in implementing telecommunications wiring systems, e.g., for high speed data networks.

Patch panels are routinely mounted between rack elements so as to permit wires or cables, e.g., unshielded twisted pair (UTP) cables, to be wired to IDCs positioned at the rear face of the patch panel, and to further permit patch plugs to be plugged into jacks or ports positioned in the front face of the patch panel. Wires/cables are routed to the desired location at the rear of the patch panel, i.e., in the bounded region defined by spaced rack elements. Patch cords are routed to the desired jack/port on the front face of the patch panel, e.g., from a raceway or the like. Thus, for cable management purposes, the patch cords are generally drawn toward one or the other side of the patch panel at the front of the rack system and, from there, routed to the desired component and/or network communication location.

Stand-off brackets typically consist of metal forms with a back panel (which may be affixed to a wall or a rack) and side walls extending from the back panel. The back panel may include a hole through which wires are leaded for connection to a wire panel attached across the side walls. Patch panels affixed to a rack and/or a telecommunications closet affords convenient access to telecommunication devices such as servers, for example, within the same rack or closet.

As the demand for the use of telecommunication devices rapidly grows, space for such devices becomes both limited and expensive. Although in some environments, patch panels are affixed to a rack, closet, and/or cabinet along with the respective devices, such as servers, the demand for space has created a need to place the patch panels in a separate location. Typically, if space is needed for more servers, for example, patch panels are mounted on a wall within a data center.

Many rows of cabinets or racks typically fill a data center or telecommunications room. Data cables from each cabinet stretch many feet to reach patch panels mounted on a far wall making immediate access more difficult and inconvenient than having the patch panels in closer proximity. Removing the patch panels from the cabinets saves cost by creating more space for servers, however, additional burdens exist as a result. Mounting patch panels on a wall requires lengthy and costly cables to stretch across burdensome lengths. Moreover, TIA/EIA requirements place cable length limitations for certain types of data cables, such as Cat 5 or 6. This in turn requires burdensome planning, organizing and cost in order to be compliant with industry requirements.

Accordingly, a need exists for mounting a patch panel in a convenient location that allows for advantageous cable management within a data center. These and other disadvantages and/or limitations are addressed and/or overcome by the assemblies and methods of the present disclosure.

### SUMMARY

The present disclosure describes assemblies and methods for a mounting a patch panel rack onto a cable pathway. In an exemplary embodiment associated with the present disclosure, an assembly is described having a patch panel rack adapted to host a plurality of ports, at least two pathway mounting brackets adapted to hold the patch panel rack, a waterfall connected to a front face of the patch panel rack, which is adapted to allow for cables to connect to the ports and maintain a desired bend radius, and mounting the brackets onto a cable management pathway. A cable management pathway is typically a ladder rack, a wire raceway, or a combination therein. In an exemplary embodiment, each of the mounting brackets defines: (i) a plurality of apertures on a front side of each of the mounting brackets adapted to accept front side bolts to hold the patch panel rack; and (ii) a plurality of apertures on a rear side of each of the mounting brackets adapted to accept rear side bolts to be mounted onto the cable management pathway.

An assembly associated with the present disclosure includes a plurality of apertures on the front side of each of the mounting brackets, which are substantially vertically aligned, and a plurality of apertures on the rear side of each of the mounting brackets that are substantially vertically aligned. The front side bolts in an exemplary embodiment are screws threadedly connected to the plurality of apertures on the front side of each of the mounting brackets. The rear side bolts are typically U bolts adapted to: (i) mount the brackets onto a cable management pathway; and (ii) connect to a double nut adapted to structurally secure the brackets to the pathway. In an exemplary embodiment, the plurality of apertures on the front side of each of the mounting brackets allow for adjustably mounting the patch panel rack onto the brackets and the plurality of apertures on the rear side of each of the mounting brackets allow for adjustably mounting the brackets onto the cable management raceway. The present disclosure provides for side mounting the brackets onto the cable management pathway.

An exemplary assembly associated with the present disclosure includes mounting brackets, each defining: (i) a substantially vertical slot on a front side of each of the mounting brackets adapted to accept a bolt to adjustably mount the patch panel rack onto the mounting brackets; and (ii) a substantially vertical slot on a rear side of each of the mounting brackets adapted to adjustably mount the mounting brackets onto the cable management pathway. In an exemplary embodiment, the waterfall is detachably connected to the front face of the rack.

The present disclosure provides for a method for accessing a patch panel from a telecommunications rack comprising: a) mounting a patch panel rack to at least two mounting brackets; and b) mounting the mounting brackets to a cable management pathway. The patch panel rack is adapted to host a plurality of ports. In an exemplary embodiment, a waterfall is connected to a front face of the patch panel rack and adapted to allow for cables electrically connected to devices associated with a telecommunications cabinet to: (i) connect to the patch panels, and (ii) maintain a desired bend radius.

Additional features, functions and benefits of the disclosed systems and assemblies will be apparent from the description which follows, particularly when read in conjunction with the appended figures.

### BRIEF DESCRIPTION OF THE DRAWINGS

To assist those of ordinary skill in the art in making and using the disclosed assemblies and methods, reference is made to the appended figures, wherein:

FIG. 1 is a schematic illustrating an exploded view of an assembly associated with the present disclosure;

FIGS. 2(a)-2(f) are schematics illustrating exemplary embodiments of mounted assemblies associated with the present disclosure;

FIGS. 3(a)-3(c) are schematics illustrating a front face view of exemplary embodiments of an assembly associated with the present disclosure mounted at different positions with respect to the pathway;

FIG. 4 is a schematic illustrating a front face view of a plurality of assemblies associated with the present disclosure mounted onto a wire raceway;

FIG. 5 is a schematic illustrating multiple assemblies associated with the present disclosure side mounted on a wire raceway overhead a telecommunications cabinet;

FIG. 6 is a schematic illustrating a front face view of a multi-assembly embodiment side mounted on a wire raceway; and

FIG. 7 is a schematic illustrating a side view of a multi-assembly embodiment side mounted on a wire raceway.

### DESCRIPTION OF EXEMPLARY EMBODIMENT(S)

Assemblies and methods are disclosed that are effective in efficiently managing cables in a data center or telecommunications closet connecting to a patch panel.

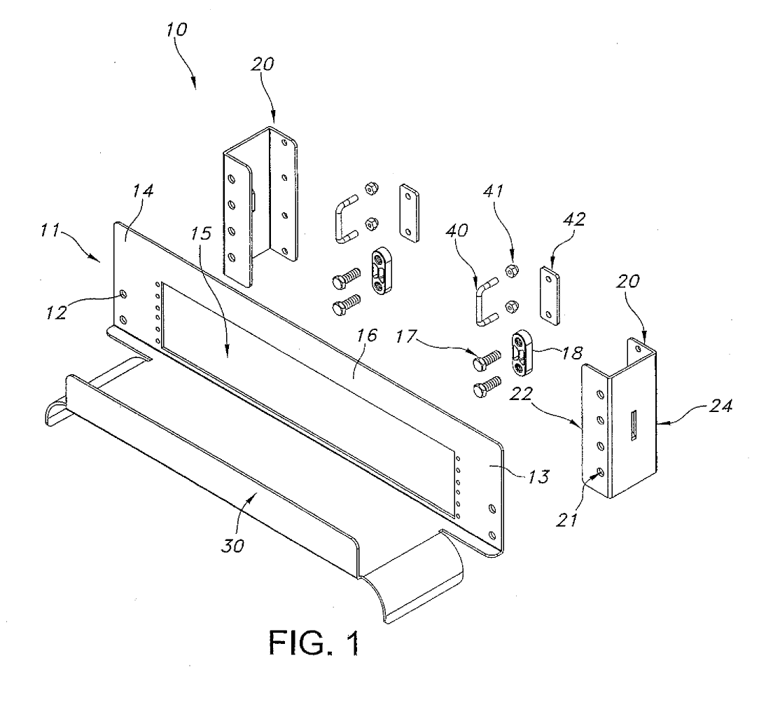

FIG. 1 is a schematic illustrating an exploded view of an assembly associated with the present disclosure. FIG. 1 is exploded to illustrate individual components of an assembly 10. Assembly 10 includes patch panel rack 11 adapted to host a plurality of ports. Typically, ports are included in a patch panel. An exemplary patch panel rack 11 is adapted to host a plurality of patch panels. In an exemplary embodiment, typically patch panel rack 11 is adapted to host either angled patch panels or flat patch panels within an opening 15. Rack 11 typically defines a plurality of apertures 12 and is adapted to be mounted onto at least one mounting bracket 20. In an exemplary embodiment, assembly 10 includes two mounting brackets 20, each defining a plurality of apertures 21 on both a front side 22 of each of mounting brackets 20 and a rear side 24 of each of mounting brackets 20. In an exemplary embodiment, rack 11 defines two apertures 12, substantially vertically aligned on each of a first end 13 and a second end 14 of front face 16 of patch panel rack 11.

Apertures 12 are adapted to align with apertures 21 such that rack 11 can be adjustably mounted to brackets 20. In an exemplary embodiment, brackets 20 each define four apertures 21 substantially vertically aligned on both front side 22 and rear side 24. Typically, threaded screws 17 connect rack 11 to brackets 20 through apertures 12 and apertures 21 on front side 22 and mate with a double nut 18 structurally securing assembly 10. In an exemplary embodiment, bolts and/or locking pins can be used as a connecting means for mounting rack 11 to brackets 20. Having a plurality of apertures on mounting bracket 20 allows for a user to conveniently adjust rack 11 vertically on brackets 20. Adjustably mounting rack 11 to brackets 20 affords a user to adjust the height and/or position of assembly 10 to accommodate for varying environments.

In an exemplary embodiment, brackets 20 and rack 11 can define an elongated slot. The elongated slot (not shown) is typically substantially vertical and adapted to allow a connecting means to provide structural stability to assembly 10. An elongated slot is adapted to allow for adjustably mounting rack 11 to brackets 20. This allows for advantageous compatibility for mounting assembly 10 in various environments.

Assembly 10 includes a waterfall 30 adapted to allow cables to connect to a patch panel mounted on patch panel rack 11 while maintaining a desired bend radius. Waterfall 30 is connected to patch panel rack 11 on a front face 16 of patch panel rack 11 just below opening 15. In an exemplary embodiment, waterfall 30 can be detachably connected to rack 11. Detachably connecting waterfall 30 allows a user to interchange the waterfall according to a desired bend radius and/or appropriate size. An exemplary assembly associated with the present disclosure includes a patch panel rack 11 having waterfall 30 molded and/or manufactured as a single component.

In an exemplary embodiment, rear side 24 of each of brackets 20 typically define four apertures 21, vertically aligned, adapted to accept a connecting means and be mounted onto a cable management pathway providing structural stability. Connecting means associated with the present disclosure are rear side bolts. In an exemplary embodiment, rear side bolts are typically U bolts 40 adapted to engage brackets 20 through apertures 21 and connect to a pathway. U bolts 40 are then secured by nuts 41. Optional spacers 42 can be used to secure brackets 20 to a desired pathway. Spacers 42 ensure a tight fit when mounting assembly 10 to a pathway and also allows for interchanging assembly 10 among different pathways. In an exemplary embodiment, assembly 10 is detachably mounted onto a raceway, thus allowing a user to move and/or adjust assembly 10 to accommodate given space constraints.

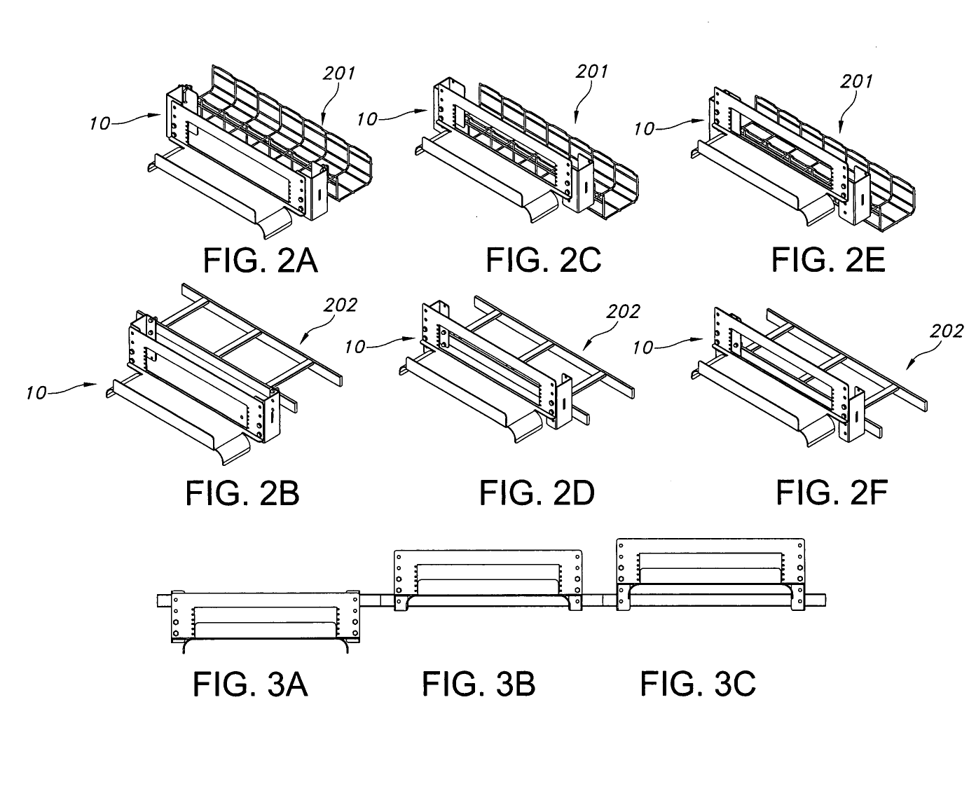

In exemplary embodiments, as shown in FIGS. 2(a)-2(f) assembly 10 is adjustably mounted to a pathway to allow maneuverability with respect to varying spatial constraints. A cable management pathway is typically a wire raceway 201 or a ladder rack 202. Wire raceways are also commonly known as wire basket trays, wire cable trays, and/or a basket. Pathways are also commonly referred to as runways or raceways. These terms are interchangeable and in no way limit the scope of the present disclosure with reference to one specific nomenclature.

FIGS. 2(a), 2(c),and 2(e) illustrate exemplary embodiments with respect to the present disclosure wherein assembly 10 is mounted to wire raceway 201. FIGS. 2(b), 2(d), and 2(f) illustrate exemplary embodiments with respect to the present disclosure wherein assembly 10 is mounted to ladder rack 202. FIG. 2(a) illustrates an exemplary embodiment of assembly 10 side mounted onto raceway 201 such that rack 11 is substantially parallel with raceway 201. Rack 11 is mounted to each of brackets 20 through the bottom two apertures 21 of front side 22. Brackets 20 are mounted to raceway 201 through the top two apertures 21 of rear side 24. FIG. 2(b) illustrates mounting assembly 10 in a substantially similar manner to FIG. 2(a) with respect to selected apertures 21, however, assembly 10 is mounted onto ladder rack 202 rather than raceway 201.

FIG. 2(c) illustrates an exemplary embodiment associated with the present disclosure of assembly 10 mounted to a wire raceway, such that rack 11 is slightly above raceway 201. FIG. 2(c) shows mounting rack 11 to brackets 20 through the bottom two apertures 21 of front side 22 and mounting brackets 20 to race way 201 through the bottom two apertures 21 of rear side 24. FIG. 2(d) illustrates mounting assembly 10 in a substantially similar manner to FIG. 2(c) with respect to selected apertures 21, however, assembly 10 is mounted onto ladder rack 202 rather than raceway 201.

FIG. 2(e) illustrates an exemplary embodiment associated with the present disclosure of assembly 10 mounted to a wire raceway, such that rack 11 is located substantially above raceway 201. FIG. 2(e) shows mounting rack 11 to brackets 20 through the top two apertures 21 of front side 22 and mounting brackets 20 to race way 201 through the bottom two apertures 21 of rear side 24. FIG. 2(f) illustrates mounting assembly 10 in a substantially similar manner to FIG. 2(e) with respect to selected apertures 21, however, assembly 10 is mounted onto ladder rack 202 rather than raceway 201.

FIGS. 3(a)-3(c) illustrate front side views of the embodiments described and illustrated in FIGS. 2(a)-2(f). FIG. 3(a) shows a front side view of assembly 10 mounted to either of raceway 201 or ladder rack 202. FIG. 3(b) shows a front side view of assembly 10 mounted to either of raceway 201 or ladder rack 202. FIG. 3(c) shows a front side view of assembly 10 mounted to either of raceway 201 or ladder rack 202.

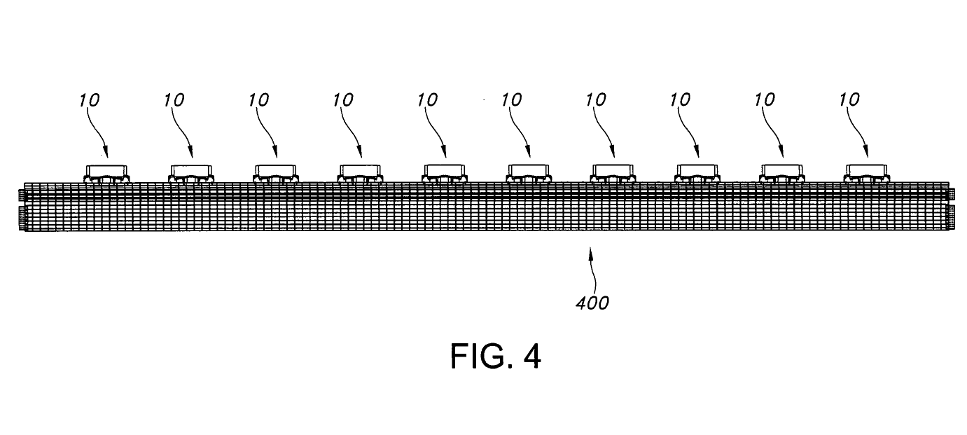

A typical data center will have several rows of telecommunications cabinets and/or closets substantially aligned in a room such as a data center. Typically hanging over the closets are cable management pathways adapted to allow for many cables to connect to designated ports and/or destinations in different areas of the room and/or leading outside the room. FIG. 4 illustrates a top view of an exemplary embodiment associated with the present disclosure of a typical wire raceway 400 having a plurality of assemblies 10 mounted therein. Raceway 400 is typically located above a row of telecommunications cabinets (not shown). Mounting an assembly 10 above each telecommunications cabinet allows for desired patch panel access within advantageous proximity and substantially reducing cable quantity. Moreover, mounting patch panels above a cabinet rather than occupying a rack space within the cabinet allows for more servers and/or desired devices to fit within the cabinet, thus saving cost on space limitations. In an embodiment associated with the present disclosure, assemblies 10 are mounted to raceway 400 such that at least one of the plurality of assemblies 10 are not parallel with at least one other of the plurality of assemblies 10. Each assembly can be positioned at a different height relative to the other assemblies in order to accommodate for spatial constraints of a given room.

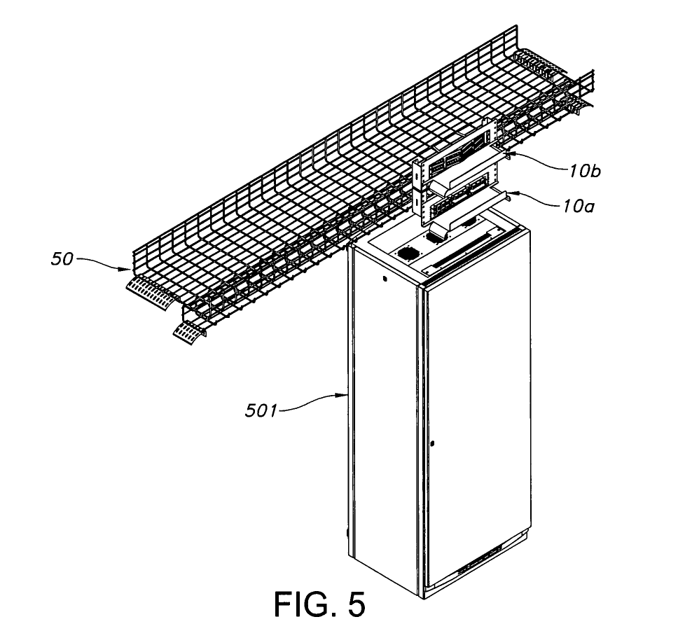

FIG. 5 illustrates an exemplary multi-level assembly embodiment. Raceway 500 runs overhead relative to telecommunications cabinet 501. Assemblies 10(a) and 10(b) are mounted onto raceway 500 according to the present disclosure described herein. Assemblies 10(b) is mounted substantially vertically aligned to assembly 10(a) directly overhead relative to cabinet 501. The embodiment shown in FIG. 5 allows devices associated cabinet 501 to have proximate electrical access to multiple patch panels. However, patch panel access associated with assemblies 10(a) and 10(b) is not limited to cabinet 501. In an exemplary embodiment, cabinets adjacent with respect to cabinet 501 may have access and electronically connect to assemblies 10(a) and/or 10(b).

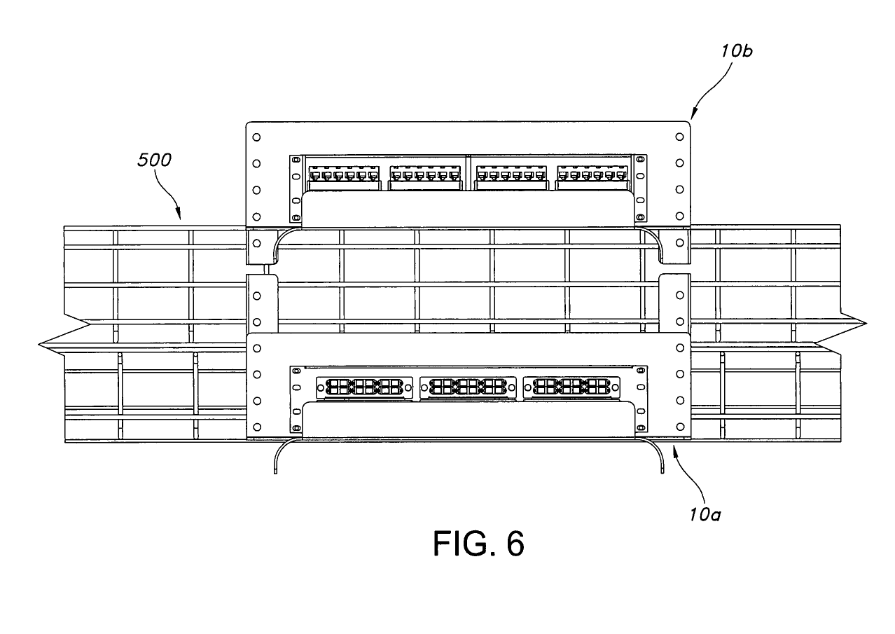

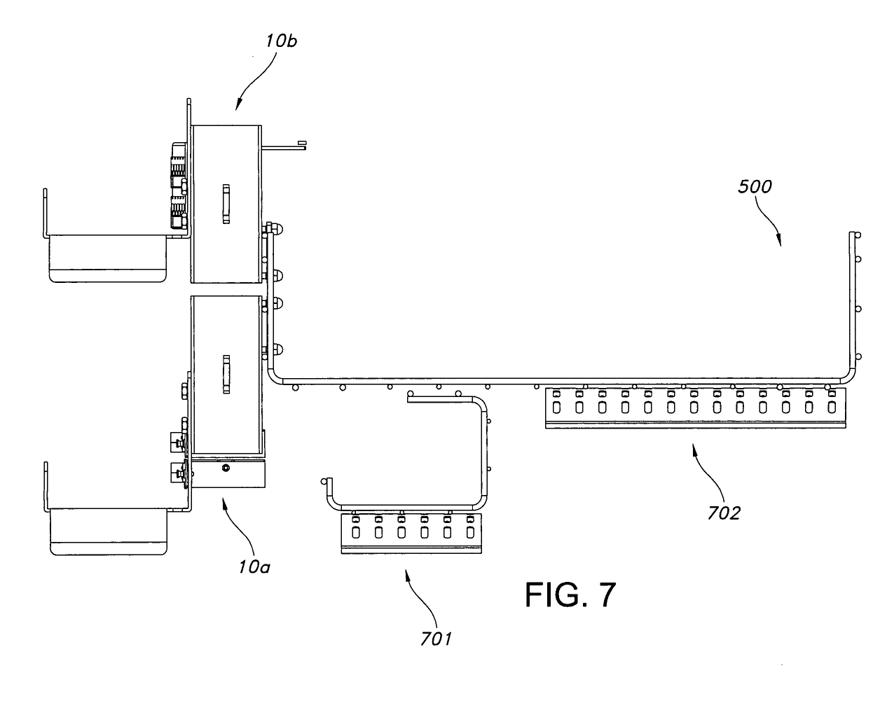

FIG. 6 illustrates a font face view of the exemplary embodiment of FIG. 5 showing exemplary mounting positions of assemblies 10(a) and 10(b) relative to raceway 500. FIG. 7 illustrates a cross sectional view of the exemplary embodiments of FIG. 5 showing functional structures associated with raceway 500. An exemplary embodiment of raceway 500 includes a cable exit guide 701 and a cable dropout 702. Guide 701 and dropout 702 provide for cables running along raceway 500 to selectively connect to desired destinations including, for example, patch panels associated with assemblies 10(a) and 10(b).

Although the present disclosure has been described with reference to exemplary embodiments and implementations thereof, the disclosed assemblies and methods are not limited to such exemplary embodiments/implementations. Rather, as will be readily apparent to persons skilled in the art from the description provided herein, the disclosed assemblies and methods are susceptible to modifications, alterations and enhancements without departing from the spirit or scope of the present disclosure. Accordingly, the present disclosure expressly encompasses such modification, alterations and enhancements within the scope thereof.

1. A patch panel rack assembly, comprising:
a) a patch panel rack adapted to host a plurality of ports; the patch panel rack being mounted onto at least two pathway mounting brackets operable to hold said patch panel rack;
b) a waterfall connected to a front face of said patch panel rack and adapted to allow for cables to (i) electrically connect to said patch panels, and (ii) maintain a desired bend radius;
wherein said at least two pathway mounting brackets are mounted onto a cable management pathway selected from the group consisting of a ladder rack, a wire raceway, and a combination thereof: and
wherein the cable management pathway extends horizontally within a room and is positioned substantially above a telecommunications cabinet.

2. (canceled)

3. An assembly according to claim 1, wherein each of said mounting brackets defines: (i) a plurality of apertures on a front side of each of said mounting brackets adapted to accept front side bolts to engage said patch panel rack; and (ii) a plurality of apertures on a rear side of each of said mounting brackets adapted to accept rear side bolts to be mounted onto said cable management pathway.

4. An assembly according to claim 3, wherein: (i) said plurality of apertures on said front side of each of said mounting brackets are substantially vertically aligned; and (ii) said plurality of apertures on said rear side of each of said mounting brackets are substantially vertically aligned.

5. An assembly according to claim 4, wherein said front side bolts are screws threadedly connected to said plurality of apertures on said front side of each of said mounting brackets.

6. An assembly according to claim 4, wherein said rear side bolts are U bolts adapted to: (i) mount each of said brackets to said cable management pathway; and (ii) engage a double nut adapted to structurally secure each of said brackets to said pathway.

7. An assembly according to claim 4, wherein said plurality of apertures on said front side of each of said mounting brackets allow for adjustably mounting said patch panel rack onto each of said brackets.

8. An assembly according to claim 4, wherein said plurality of apertures on said rear side of each of said mounting brackets allow for adjustably mounting said brackets onto said cable management pathway.

9. An assembly according to claim 1, wherein said brackets are side mounted onto said cable management pathway.

10. An assembly according to claim 1, wherein each of said brackets defines: (i) a substantially vertical slot on a front side of each of said mounting brackets adapted to accept a bolt to adjustably mount said patch panel rack onto each of said mounting brackets; and (ii) a substantially vertical slot on a rear side of each of said mounting brackets adapted to adjustably mount each of said mounting brackets onto said cable management pathway.

11. An assembly according to claim 1, wherein said waterfall is detachably connected to said front face of said patch panel rack.

12. A method for accessing a port from a telecommunications rack comprising:
a) mounting a patch panel rack onto at least two mounting brackets;
b) mounting said mounting brackets onto a cable management pathway;
wherein said patch panel rack is adapted to host a plurality of ports;
wherein a waterfall is connected to a front face of said patch panel rack and is adapted to allow for cables electrically connected to devices associated with a telecommunications cabinet to: (i) connect to said ports, and (ii) maintain a desired bend radius.
wherein the cable management pathway is selected from the group consisting of a ladder rack, a wire raceway, and a combination thereof: and
wherein the cable management pathway extends horizontally within a room and is positioned substantially above the telecommunications cabinet.

13. (canceled)

14. A method according to claim 12, wherein each of said mounting brackets defines: (i) a plurality of apertures on a front side of each of said mounting brackets adapted to accept front side bolts to engage said patch panel rack; and (ii) a plurality of apertures on a rear side of each of said mounting brackets adapted to accept rear side bolts to be mounted onto said cable management pathway.

15. A method according to claim 14, wherein: (i) said plurality of apertures on said front side of each of said mounting brackets are substantially vertically aligned; and (ii) said plurality of apertures on said rear side of each of said mounting brackets are substantially vertically aligned.

16. A method according to claim 15, wherein said front side bolts are screws threadedly connected to said plurality of apertures on said front side of each of said mounting brackets.

17. A method according to claim 15, wherein said rear side bolts are U bolts adapted to: (i) mount said brackets to said cable management pathway; and (ii) engage a double nut adapted to structurally secure said brackets to said pathway.

18. A method according to claim 15, wherein said plurality of apertures on said front side of each of said mounting brackets allow for adjustably mounting said patch panel rack onto said brackets.

19. A method according to claim 15, wherein said plurality of apertures on said rear side of each of said mounting brackets allow for adjustably mounting said brackets onto said cable management pathway.

20. A method according to claim 15, wherein said brackets are side mounted onto said cable management pathway.

21. A method according to claim 15, wherein each of said brackets defines: (i) a substantially vertical slot on a front side of each of said mounting brackets adapted to accept a bolt to adjustably mount said patch panel rack onto each of said mounting brackets; and (ii) a substantially vertical slot on a rear side of each of said mounting brackets adapted to adjustably mount said mounting brackets onto said cable management pathway.

22. A method according to claim 15, wherein said waterfall is detachably connected to said front face of said patch panel rack.

23. An assembly according to claim 1, wherein the mounting brackets support the weight of the patch panel rack and any ports hosted on the patch panel rack.

24. An assembly according to claim 23, wherein the cable management pathway supports the weight of the mounting brackets, the patch panel rack and any ports hosted on the patch panel rack.

25. A method according to claim 12, wherein the mounting brackets support the weight of the patch panel rack and any ports hosted on the patch panel rack.

26. An assembly according to claim 25, wherein the cable management pathway supports the weight of the mounting brackets, the patch panel rack and any ports hosted on the patch panel rack.
